(19) United States
(12) Patent Application Publication
(10) Pub. No.: US 2025/0103356 A1
(43) Pub. Date: Mar. 27, 2025

(54) PLUG-IN LOADING METHOD AND DEVICE

(71) Applicant: Beijing Zitiao Network Technology Co., Ltd., Haidian District, Beijing (CN)

(72) Inventors: Jie YANG, Beijing (CN); Feifan XU, Beijing (CN)

(21) Appl. No.: 18/730,711

(22) PCT Filed: Jan. 13, 2023
(86) PCT No.: PCT/CN2023/071985

§ 371 Date: Jul. 19, 2024

(30) Foreign Application Priority Data
Jan. 21, 2022 (CN) 202210070913.5

(51) Int. Cl. G06F 9/445; G06F 8/41

(52) U.S. Cl. CPC G06F 9/44526; G06F 8/41

(57) ABSTRACT

Embodiments of the present disclosure relate to the technical field of computers, and provide a plug-in loading method and device. The method includes: receiving a first operation for a target application, the first operation being configured to trigger the target application to load a first plug-in; determining whether the first plug-in is written in a preset language; determining whether the first plug-in references a function module that does not belong to the first plug-in in response to the first plug-in being written in the preset language; in response to a target function module that does not belong to the first plug-in is referenced by the first plug-in, generating a second plug-in by converting a reference to the target function module by the first plug-in to a reference to the target function module by a module packager of the target application; and loading the second plug-in through the target application.

### CROSS-REFERENCE TO RELATED APPLICATIONS

This application is based on and claims the benefit of priority to the Chinese patent application No. 202210070913.5 filed on Jan. 21, 2022, which is hereby incorporated by reference in its entirety into the present application.

### TECHNICAL FIELD

This disclosure relates to the field of computer technology, particularly to a plug-in loading method and device.

### BACKGROUND

A plug-in is a computer program written based on application program interfaces that follow certain standards and is typically used to extend the functionality of an application program. With the rapid development of computers, users have increasingly personalized demands for the service functions of applications. Therefore, the scalability of applications becomes more and more important. To ensure the scalability of applications, applications usually support the loading of plug-ins.

### SUMMARY

Embodiments of the present disclosure provide the following technical solution.

In a first aspect, an embodiment of the present disclosure provides a plug-in loading method, comprising:
receiving a first operation for a target application, wherein the first operation is configured to trigger the target application to load a first plug-in;
determining whether the first plug-in is written in a preset language;
determining whether the first plug-in references a function module that does not belong to the first plug-in in response to the first plug-in being written in the preset language;
in response to a target function module that does not belong to the first plug-in is referenced by the first plug-in, generating a second plug-in by converting a reference to the target function module by the first plug-in to a reference to the target function module by a module packager of the target application; and
loading the second plug-in through the target application.

As an optional embodiment of the present disclosure, the determining whether the first plug-in references the function module that does not belong to the first plug-in comprises:
determining whether the first plug-in references a function module by name;
in response to the first plug-in referencing the function module by name, determining that the first plug-in references the function module that does not belong to the first plug-in;
in response to the first plug-in not referencing the function module by name, determining whether the first plug-in references a function module by path;
in response to the first plug-in referencing the function module by path, determining whether the function module referenced by path by the first plug-in belongs to the first plug-in; and
in response to the function module referenced by path by the first plug-in not belonging to the first plug-in, determining that the function module that does not belong to the first plug-in is referenced by the first plug-in.

As an optional embodiment of the present disclosure, the generating the second plug-in by converting the reference to the target function module by the first plug-in to the reference to the target function module by the module packager of the target application comprises:
obtaining an identifier of the target function module based on a first mapping relationship in response to the first plug-in referencing the target function module by name, wherein the first mapping relationship comprises a mapping relationship between a name of the target function module and an identifier of the target function module; and
generating the second plug-in by converting the reference to the target function module by the first plug-in to the reference to the target function module by the module packager of the target application according to the identifier of the target function module.

As an optional embodiment of the present disclosure, the generating the second plug-in by converting the reference to the target function module by the first plug-in to the reference to the target function module by the module packager of the target application comprises:
obtaining an identifier of the target function module based on a second mapping relationship in response to the first plug-in referencing the target function module by a module path, wherein the second mapping relationship comprises a mapping relationship between a path of the target function module and an identifier of the target function module; and
generating the second plug-in by converting the reference to the target function module by the first plug-in to the reference to the target function module by the module packager of the target application according to the identifier of the target function module.

As an optional embodiment of the present disclosure, the loading method further comprises:
in response to the first plug-in being not written in the preset language, converting the first plug-in to a plug-in written in the preset language.

As an optional implementation of the present disclosure, the converting the first plug-in to the plug-in written in the preset language comprises:
converting the first plug-in to the plug-in written in the preset language by a compiler integrated into the target application.

As an optional embodiment of the present disclosure, the loading method further comprises:
generating an executable file corresponding to the compiler before the converting the first plug-in to the plug-in written in the preset language by the compiler integrated into the target application; and
encapsulating the executable file corresponding to the compiler into a command line for plug-in language conversion in the target application.

As an optional implementation of the present disclosure, a compilation configuration file of the compiler is in a resource file of the target application.

As an optional embodiment of the present disclosure, the loading method further comprises:
generating a declaration file in a preset directory of the target application before the converting the first plug-in to the plug-in written in the preset language by the compiler integrated into the target application, wherein the declaration file is configured for indicating a function module allowed to be referenced by a plug-in in the target application.

As an optional implementation of the present disclosure, the converting the first plug-in to the plug-in written in the preset language by the compiler integrated into the target application comprises:
searching for the declaration file in the target application; and
converting the first plug-in to the plug-in written in the preset language by the compiler integrated into the target application and the declaration file.

In a second aspect, an embodiment of the present disclosure provides a plug-in loading apparatus, comprising:
a receiving unit configured to receive a first operation for a target application, wherein the first operation is configured to trigger the target application to load a first plug-in;
a processing unit configured to determine whether the first plug-in is written in a preset language; and determine whether the first plug-in references a function module that does not belong to the first plug-in in response to the first plug-in being written in the preset language; and
a loading unit configured to, in response to a target function module that not belonging to the first plug-in is referenced by the first plug-in, generate a second plug-in by converting a reference to the target function module by the first plug-in to a reference to the target function module by a module packager of the target application; and load the second plug-in by the target application.

As an optional embodiment of the present disclosure, the processing unit is further configured to:
determine whether the first plug-in references a function module by name;
in response to the first plug-in referencing the function module by name, determine that the first plug-in references the function module that does not belong to the first plug-in;
in response to the first plug-in not referencing the function module by name, determine whether the first plug-in references a function module by path;
in response to the first plug-in referencing the function module by path, determine whether the function module referenced by path by the first plug-in belongs to the first plug-in; and
in response to the function module referenced by path by the first plug-in does not belong to the first plug-in, determine that the function module that does not belong to the first plug-in is referenced by the first plug-in.

As an optional embodiment of the present disclosure, the loading unit is further configured to:
obtain an identifier of the target function module based on a first mapping relationship in response to the first plug-in referencing the target function module by name, wherein the first mapping relationship comprises a mapping relationship between a name of the target function module and an identifier of the target function module; and
generate the second plug-in by converting the reference to the target function module by the first plug-in to the reference to the target function module by the module packager of the target application according to the identifier of the target function module.

As an optional embodiment of the present disclosure, the loading unit is further configured to:
obtain an identifier of the target function module based on a second mapping relationship in response to the first plug-in referencing the target function module by a module path, wherein the second mapping relationship comprises a mapping relationship between a path of the target function module and an identifier of the target function module; and
generate the second plug-in by converting the reference to the target function module by the first plug-in to the reference to the target function module by the module packager of the target application according to the identifier of the target function module.

As an optional embodiment of the present disclosure, the processing unit is further configured to, in response to the first plug-in being not written in the preset language, convert the first plug-in to a plug-in written in the preset language.

As an optional implementation of the present disclosure, the processing unit is further configured to convert the first plug-in to the plug-in written in the preset language by a compiler integrated into the target application.

As an optional implementation of the present disclosure, the processing unit is further configured to generate an executable file corresponding to the compiler before the converting the first plug-in to the plug-in written in the preset language by the compiler integrated into the target application; and encapsulate the executable file corresponding to the compiler into a command line for plug-in language conversion in the target application.

As an optional implementation of the present disclosure, a compilation configuration file of the compiler is in a resource file of the target application.

As an optional implementation of the present disclosure, the processing unit is further configured to generate a declaration file in a preset directory of the target application before the converting the first plug-in to the plug-in written in the preset language by the compiler integrated into the target application, wherein the declaration file is configured for indicating a function module allowed to be referenced by a plug-in in the target application.

As an optional embodiment of the present disclosure, the processing unit is further configured to search for the declaration file in the target application; and convert the first plug-in to the plug-in written in the preset language by the compiler integrated into the target application and the declaration file.

In a third aspect, an embodiment of the present disclosure provides an electronic device, comprising: a memory; a processor coupled to the memory, the processor configured to, based on instructions stored in the memory, carry out the plug-in loading method according to any of the above embodiments.

In a fourth aspect, an embodiment of the present disclosure provides a computer-readable storage medium stored thereon a computer program that, when executed by a computing device, causes the computing device to implement the plug-in loading method according to any of the above embodiments.

In a fifth aspect, an embodiment of the present disclosure provides a computer program product that, when running on a computer, causes the computer to implement the plug-in loading method according to any of the above embodiments.

In a sixth aspect, an embodiment of the present disclosure provides a computer program, including: instructions that, when executed by a processor, cause the processor to implement the plug-in loading method according to any of the above embodiments.

### BRIEF DESCRIPTION OF THE DRAWINGS

Herein, the accompanying drawings, which are incorporated in and constitute a part of this specification, illustrate embodiments of the present disclosure and, together with the description, serve to explain the principles of the present disclosure.

In order to more clearly explain the embodiments of the present invention or the technical solutions in the prior art, a brief introduction will be given below for the drawings required to be used in the description of the embodiments or the prior art. It is obvious that, for a person skilled in the art, he or she may also acquire other drawings according to such drawings on the premise that no inventive effort is involved.

FIG. 1 is a flowchart of a plug-in loading method provided by an embodiment of the present disclosure;

FIG. 2 is another flowchart of the plug-in loading method provided by an embodiment of the present disclosure;

FIG. 3 is a schematic structure diagram of a plug-in loading apparatus provided by an embodiment of the present disclosure;

FIG. 4 is a schematic diagram showing the hardware structure of an electronic device provided by an embodiment of the present disclosure.

### DETAILED DESCRIPTION

In order to better understand the above objects, features and advantages of the present disclosure, the scheme of the present disclosure will be further described below. It should be noted that, in the case of no conflict, the embodiments and the features of the embodiments of the present disclosure may be combined with each other.

Many specific details are set forth in the following description to facilitate a full understanding of the present disclosure, but the present disclosure can also be implemented in other ways different from those described herein. Obviously, embodiments described in the description are only some embodiments of the present disclosure, and are not all of embodiments thereof.

In the present disclosed embodiment, words such as “as an illustration” or “for example” are used to provide examples, illustrations, or explanations. Any embodiments or designs described with “as an illustration” or “for example” in the embodiments of the present disclosure should not be construed as being more preferred or advantageous than other embodiments or designs. In particular, the use of words such as “as an illustration” or “for example” is intended to present relevant concepts in a specific way. Moreover, in the description of the embodiments of the present disclosure, unless otherwise indicated, the phrase “a plurality of” means “two or more”.

Currently, most applications support loading plug-ins, but the loaded plug-ins can only use function modules that are defined during the development process of the plug-ins and do not support the use of function modules that do not belong to the plug-ins, resulting in very limited extensibility of the plug-ins.

A plug-in written in JavaScript (JS plug-in for short) can be a purely logical plug-in that does not reference any function modules, a plug-in that references custom function modules in the plug-in, a plug-in that references function modules in the application that loads the plug-in, or a plug-in that references function modules in the JavaScript runtime environment framework. A plug-in written in JavaScript reference to a functional module through a require method. When a function module of an application is packaged using Webpack, each function is stored in a closure object (modules_map), and the references (require methods) in TypeScript, TSX, or JavaScript plug-ins replaced with references (webpack_require methods) to the function modules by the module packager (Webpack) based on identifiers of the function modules. When a function module is referenced, the module packager finds a truly referenced function module based on an identifier corresponding to the function module, and then references the truly referenced module. That is, during the running process of an application, the way to reference a function module integrated in the application comprises: referencing an identifier of a function module in a webpack_require method; in response to a plug-in not referencing any function module or a referenced function module being a custom function module in the plug-in, directly loading the plug-in by the application; in response to the plug-in references a function module in the application or a function module in the JavaScript runtime framework, since the plug-in references the function module via a require method, but the application needs to reference the function module via a webpack_require method, the application cannot directly load this plug-in. Instead, it needs to convert the reference to the function module in the require method to a reference to the function module in a webpack_require method, in order to normally load the plug-in.

Based on the above content, embodiments of the present disclosure provides a plug-in loading method comprising, in response a target function module referenced in a first plug-in not belonging to the first plug-in, converting a reference to the target function module in the first plug-in (a reference to the target function module in a require method) to a reference to the target function module by a module packager of the application (a reference to the target function module in a webpack_require method), and then loading the plug-in, so as to ensure that the plug-in can be loaded normally by the application.

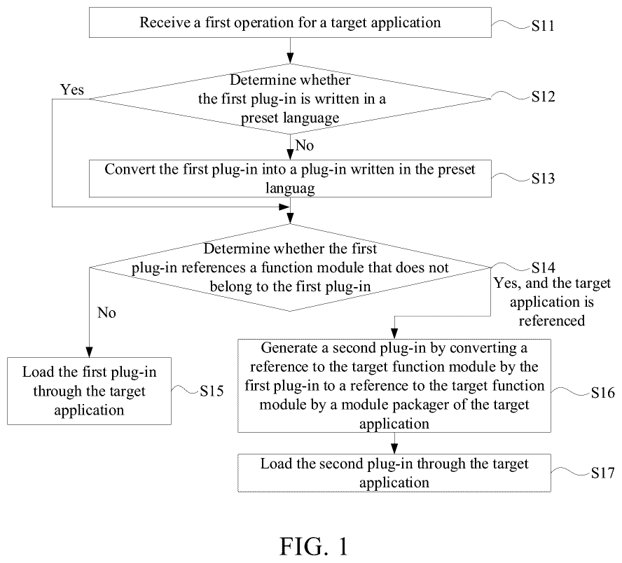

An embodiment of the present disclosure provides a plug-in loading method. As shown in FIG. 1, the plug-in loading method comprises steps S11 to S17.

In S11, a first operation for a target application is received.

The first operation is used to trigger the target application to load a first plug-in.

The first operation in this embodiment of the present disclosure can be an operation for launching the target application, or an operation for launching a specified function of the target application. The first operation can be a touch operation, a voice input, or a specific gesture. The specific gesture can be any of the following: a click gesture, a slide gesture, a pressure-sensing gesture, a long-press gesture, an area-varying gesture, a double-press gesture, or a double-click gesture.

In S12, it is determined whether the first plug-in is written in a preset language.

The preset language in the embodiments of this disclosure can be configured based on types of plug-ins supported by the application. For example, in response to the target application supporting loading of JS plug-ins, the preset language can be JavaScript, and in response to the target application supporting loading of TS plug-ins, the preset language can be TypeScript.

In the step S12 above, in response to determining that the first plug-in being not written in the preset language, step S13 is performed.

In S13, the first plug-in is converted into a plug-in written in the preset language.

In response to determining that the first plug-in being a plug-in written in the preset language in step S12, step S13 is skipped and step S14 below is directly performed.

In S14, it is determined whether the first plug-in references a function module that does not belong to the first plug-in.

In step S14 above, in response to the first plug-in not referencing a function module that does not belong to the first plug-in, step S15 is performed.

Specifically, there are two situations where the first plug-in does not reference a function module that does not belong to the first plug-in.

Situation 1: The first plug-in is a purely logical plug-in that does not reference any function modules.

Situation 2: The first plug-in references one or more function modules, but the one or more function modules are plug-ins customized during writing the first plug-in. That is, the first plug-in only references function module(s) that belong to the first plug-in.

In S15, the first plug-in is loaded through the target application.

In step S14 above, in response to the first plug-in referencing a target function module that does not belong to the first plug-in, step S16 is performed.

In S16, a second plug-in is generated by converting a reference to the target function module by the first plug-in to a reference to the target function module by a module packager of the target application.

Specifically, in response to the preset language being JavaScript, step S16 comprises: converting a reference to the target function module achieved by a require method in the first plug-in to a reference to the target function module achieved by a webpack_require method to generate the second plug-in.

In S17, the second plug-in is loaded through the target application.

The plug-in loading method provided in this embodiment comprises: upon receiving a first operation for triggering a target application to load a first plug-in, determining whether the first plug-in is a plug-in written in a preset language; in response to the first plug-in being written in a preset language, further determining whether the first plug-in references a function module that does not belong to the first plug-in; in response to the first plug-in referencing the target function module that does not belong to the first plug-in, converting a reference to a target function module by the first plug-in to a reference to the target function module by a packager of the target application to generate a second plug-in; and finally loading the second plug-in through the target application. Since the plug-in loading method provided in this embodiment of the present disclosure can convert, in response to the first plug-in referencing the target function module that does not belong to the first plug-in, the reference to the target function module in the first plug-in to the reference to the target function module by the packager of the target application to generate the second plug-in, and load the second plug-in through the target application, the plug-in loading method provided in this embodiment can reference a target function module normally even if the plug-in references an external function module, and then load the plug-in normally. Therefore, the plug-in loading method provided in this embodiment can solve the problem that a plug-in can only use a function module defined in the plug-in development process.

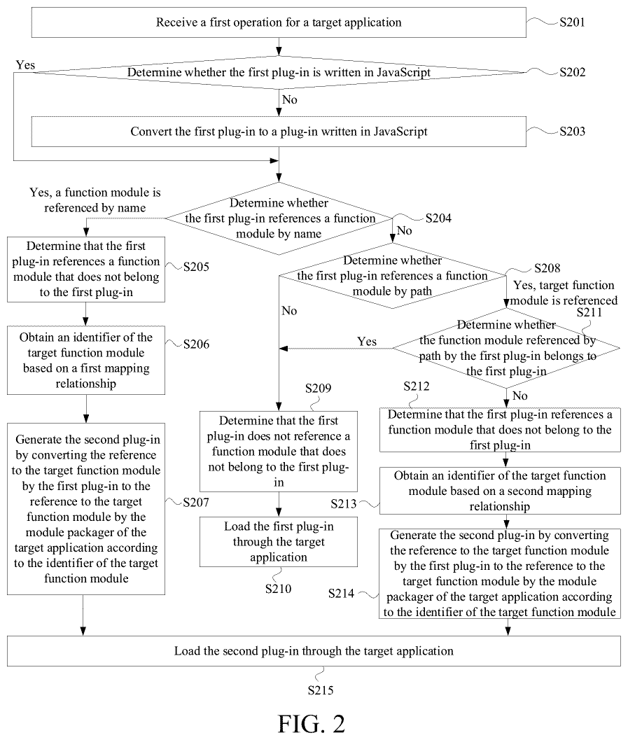

The above embodiments will be extended and refined below with, for example, JavaScript as the preset language. Referring to FIG. 2, the plug-in loading method provided in an embodiment of the present disclosure includes the following steps.

In S201, a first operation for a target application is received.

The first operation is configured to trigger the target application to load a first plug-in.

In S202, it is determined whether the first plug-in is written in JavaScript.

In the step S202 above, in response to determining that the first plug-in is not written in JavaScript, step S203 is performed.

In S203, the first plug-in is converted to a plug-in written in JavaScript.

As an optional implementation of the present disclosure, step S203 (converting the first plug-in to the plug-in written in JavaScript) comprises:
converting the first plug-in to the plug-in written in JavaScript by a compiler (tsc. js) integrated into the target application.

For example, a compiler can be integrated in the target application to translate a plug-in written in TypeScript or TSX to a plug-in written in JavaScript, and a plug-in written in TypeScript or TSX can be translated to a plug-in written in JavaScript by the integrated compiler.

As an optional implementation of the present disclosure, integrating the compiler in the target application to translate a plug-in written in TypeScript or TSX to a plug-in written in JavaScript includes the following steps a and b:
Step a: generating an executable file corresponding to the compiler;
Step b: encapsulating the executable file corresponding to the compiler into a command line for plug-in language conversion in the target application.

In the above embodiment, because a corresponding executable file is generated based on the compiler, and the generated executable file is integrated into a command line of the target application, a problem of the target application not being able to find the compiler and a problem of the compiler having to rely on executable files in the runtime environment can be avoided.

As an optional implementation of the present disclosure, based on integrating the compiler in the target application to translate a plug-in written in TypeScript or TSX to a plug-in written in JavaScript, the plug-in loading method provided in the embodiment of the present disclosure further comprises:
providing a compilation configuration file of the compiler in a resource file of the target application.

In the above embodiment, since the compilation configuration file of the compiler is provided in the resource file of the target application, the above embodiment can avoid generating unnecessary compilation configuration files and allow the compilation configuration file to be modified conveniently and quickly.

The plug-in loading method provided by an embodiment of the present disclosure further comprises: generating a declaration file in a preset directory of the target application before converting the first plug-in to a plug-in written in JavaScript by a compiler integrated into the target application, wherein the declaration file is configured for indicating a function module allowed to be referenced by a plug-in in the target application.

As an example, the “declaration” attribute in the tsconfig.json of the target application can be changed to “true” to generate the declaration file.

Specifically, when a plug-in writer writes a plug-in, if a function module in the target application is referenced, the plug-in cannot be successfully compiled by a compiler because the function module in the target application is not defined in the plug-in. The above embodiment further provides a method for generating a declaration file in a preset directory of the target application. Thus, a function module in the target application can be defined (declared) via the declaration file, ensuring that the plug-in can be successfully compiled by the compiler.

That is, converting the first plug-in to a plug-in written in JavaScript by a compiler integrated into the target application comprises:
searching for the declaration file in the target application;
converting the first plug-in to a plug-in written in JavaScript by the compiler integrated into the target application and the declaration file.

In response to determining that the first plug-in is a plug-in written in JavaScript in step S202 above, step S203 is skipped and step S204 below is directly performed.

In S204, it is determined whether the first plug-in references a function module by name.

Specifically, since there is no path provided for function modules in the framework of the JS runtime environment, a function module in the framework of the JS runtime environment is referenced by its name in a plug-in.

In step S204 above, in response to the first plug-in referencing a function module by name, it can be determined that the first plug-in references a function module in the framework of the JS runtime environment. Therefore, the following step S205 is performed.

In S205, it is determined that the first plug-in references a function module that does not belong to the first plug-in.

Furthermore, in response to the first plug-in referencing a target function module by name, the plug-in loading method provided in an embodiment of the present disclosure further comprises steps S206 and S207 for converting a reference to the target function module in the JS runtime environment framework present in the first plug-in to a reference to the target function module by the module packager of the target application.

In S206, an identifier of the target function module is obtained based on a first mapping relationship.

The first mapping relationship includes a mapping relationship between a name of the target function module and the identifier of the target function module.

For example, the identifier of a function module can be its unique Identify Document (ID) in the modules_map.

Specifically, a mapping relationship table can be maintained in the target application that stores the mapping relationship between function modules and their corresponding identifiers in the JS runtime environment framework, and the identifier of the target function module can be obtained by looking up in the table.

For example, the first mapping relationship may be as shown in Table 1 below.

TABLE 1

| Name of function | Identifier of |
|---|---|
| module | function module |
| Function module A | 001 |
| Function module B | 002 |
| . . . | . . . |
| Function module N | XXX |

In S207, the second plug-in is generated by converting the reference to the target function module by the first plug-in to the reference to the target function module by the module packager of the target application according to the identifier of the target function module.

As shown in the above example, if a target function module is function module B in Table 1, converting the reference to the target function module in the first plug-in to the reference to the target function module by the module packager of the target application comprises:
determining the identifier “002” of the target function module based on require (“Function Module B”) and Table 1, and then converting require (“Function Module B”) into a reference to the target function module by the module packager of the target application, i.e., webpack-require (“002”), based on the identifier “002” of the target function module.

In step S204 above, in response to the first plug-in not referencing a function module by name, step S208 is performed.

In S208, it is determined whether the first plug-in references a function module by path.

In step S208 above, in response to the first plug-in not referencing a function module by path, steps S209 and S210 are performed. Since a JS plug-in can only reference an external function module by name or path, and the first plug-in does not reference a function module by name or path, steps S209 and S210 are performed.

In S209, it is determined that the first plug-in does not reference a function module that does not belong to the first plug-in.

In S210, the first plug-in is loaded through the target application.

In step S209 above, in response to the first plug-in referencing a target function module by path, since a JS plug-in may reference a function module customized during the plug-in writing process or a function module in the application by path, in response to the first plug-in referencing a function module by path, in order to determine whether the first plug-in references a function module that does not belong to the first plug-in, step S211 could be performed to determine whether the function module referenced by the first plug-in by path is a function module in the first plug-in.

In S211, it is determined whether the function module referenced by path by the first plug-in belongs to the first plug-in.

In step S211 above, in response to the function module referenced by path in the first plug-in belonging to the first plug-in, it can be determined that the first plug-in does not reference a function module that does not belong to the first plug-in. Therefore, steps S209 and S210 above are performed; otherwise, in response to the target function module referenced by path in the first plug-in not belonging to the first plug-in, step S212 below is performed.

In S212, it is determined that the first plug-in references a function module that does not belong to the first plug-in.

In addition, in response to the first plug-in referencing the target function module that does not belong to the first plug-in by path, the plug-in loading method provided in an embodiment of the present disclosure further comprises steps S213 and S214 for converting a reference to the target function module in the target application by the first plug-in into a reference to the target function module by the module packager of the target application.

In S213, an identifier of the target function module is obtained based on a second mapping relationship.

The second mapping relationship includes a mapping relationship between the path of the target function module and the identifier of the target function module.

Similarly, the identifier of a function module can be its unique ID in the modules_map.

Specifically, a mapping relationship table can be maintained in the target application that stores the mapping relationship between function modules of the target application and their corresponding identifiers, and the identifier of the target function module can be obtained by looking up in the table.

For example, the second mapping relationship may be as shown in Table 2 below.

TABLE 2

| Path of function | Identifier of |
|---|---|
| module | function module |
| Path 1 | 0001 |
| Path 2 | 0002 |
| . . . | . . . |
| Path N | XXXX |

In S214, the second plug-in is generated by converting the reference to the target function module by the first plug-in to the reference to the target function module by the module packager of the target application according to the identifier of the target function module.

As shown in the above example, if a path of a target function module is path 1 in Table 2, converting the reference to the target function module by the first plug-in to the reference to the target function module by the module packager of the target application comprises:

determining the identifier “0001” of the target function module based on require (“path 1”) and Table 2, and then converting require (“path 1”) into a reference to the target function module by the module packager of the target application, i.e., webpack-require (“0001”), based on the identifier “0001” of the target function module.

In S215, the second plug-in is loaded through the target application.

The plug-in loading method provided in this embodiment comprises: upon receiving a first operation for triggering a target application to load a first plug-in, determining whether the first plug-in is written in JavaScript; in response to the first plug-in being written in JavaScript, further determining whether the first plug-in references a function module that does not belong to the first plug-in; in response to the first plug-in referencing a target function module not belonging to the first plug-in, generating a second plug-in by converting a reference to a target function module in the first plug-in to a reference to the target function module by a packager of the target application; and finally loading the second plug-in through the target application. Since the plug-in loading method provided in this embodiment of the present disclosure can convert a reference to the target function module in the first plug-in, which does not belong to the first plug-in, to a reference to the target function module by the packager of the target application to generate a second plug-in, and load the second plug-in through the target application, the plug-in loading method provided in this embodiment can reference a target function module normally in a case where the plug-in references an external function module, and then load the plug-in normally. Therefore, the plug-in loading method provided in this embodiment can solve the problem that a plug-in can only use the function modules defined in the plug-in development process.

Based on the same inventive concept, as an implementation of the above method, a terminal device and a server are further provided by embodiments of the present disclosure corresponding to the above method embodiments. For ease of reading, the contents of the above method embodiments will not be explained in detail in this embodiment, but it should be clarified that all the contents of the above method embodiment can be achieved in the terminal device and server of this embodiment.

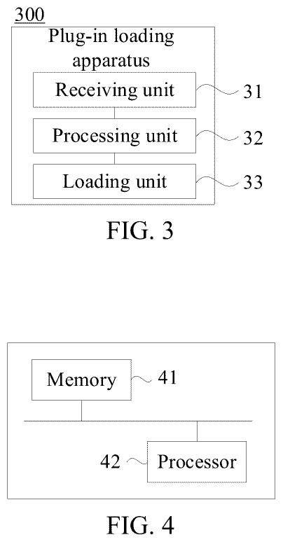

An embodiment of the present disclosure provides a plug-in loading apparatus. FIG. 3 is a schematic structure diagram of the plug-in loading apparatus. As shown in FIG. 3, the terminal device 300 comprises:
a receiving unit 31 configured to receive a first operation for a target application, wherein the first operation is configured to trigger the target application to load a first plug-in;
a processing unit 32 configured to determine whether the first plug-in is written in a preset language; and determine whether the first plug-in references a function module that does not belong to the first plug-in in response to the first plug-in being written in the preset language;
a loading unit 33 configured to, in response to a target function module that not belonging to the first plug-in is referenced by the first plug-in, generate a second plug-in by converting a reference to the target function module by the first plug-in to a reference to the target function module by a module packager of the target application; and load the second plug-in by the target application.

As an optional embodiment of the present disclosure, the processing unit 32 is particularly configured to: determine whether the first plug-in references a function module by name; in response to the first plug-in referencing the function module by name, determine that the first plug-in references the function module that does not belong to the first plug-in; in response to the first plug-in not referencing the function module by name, determine whether the first plug-in references a function module by path; in response to the first plug-in referencing the function module by path, determine whether the function module referenced by path by the first plug-in belongs to the first plug-in; and in response to the function module referenced by path by the first plug-in does not belong to the first plug-in, determine that the function module that does not belong to the first plug-in is referenced by the first plug-in.

As an optional embodiment of the present disclosure, the loading unit 33 is particularly configured to: obtain an identifier of the target function module based on a first mapping relationship in response to the first plug-in referencing the target function module by name, wherein the first mapping relationship comprises a mapping relationship between a name of the target function module and an identifier of the target function module; and generate the second plug-in by converting the reference to the target function module by the first plug-in to the reference to the target function module by the module packager of the target application according to the identifier of the target function module.

As an optional embodiment of the present disclosure, the loading unit 33 is particularly configured to: obtain an identifier of the target function module based on a second mapping relationship in response to the first plug-in referencing the target function module by a module path, wherein the second mapping relationship comprises a mapping relationship between a path of the target function module and an identifier of the target function module; and generate the second plug-in by converting the reference to the target function module by the first plug-in to the reference to the target function module by the module packager of the target application according to the identifier of the target function module.

As an optional embodiment of the present disclosure, the processing unit 32 is further configured to, in response to the first plug-in being not written in the preset language, convert the first plug-in to a plug-in written in the preset language.

As an optional implementation of the present disclosure, the processing unit 32 is further configured to convert the first plug-in to the plug-in written in the preset language by a compiler integrated into the target application.

As an optional implementation of the present disclosure, the processing unit 32 is further configured to generate an executable file corresponding to the compiler before the converting the first plug-in to the plug-in written in the preset language by the compiler integrated into the target application; and encapsulate the executable file corresponding to the compiler into a command line for plug-in language conversion in the target application.

As an optional implementation of the present disclosure, a compilation configuration file of the compiler is in a resource file of the target application.

As an optional implementation of the present disclosure, the processing unit 32 is further configured to generate a declaration file in a preset directory of the target application before the converting the first plug-in to the plug-in written in the preset language by the compiler integrated into the target application, wherein the declaration file is configured for indicating a function module allowed to be referenced by a plug-in in the target application.

As an optional embodiment of the present disclosure, the processing unit 32 is particularly configured to search for the declaration file in the target application; and convert the first plug-in to the plug-in written in the preset language by the compiler integrated into the target application and the declaration file.

The plug-in loading apparatus provided in this embodiment can perform the plug-in loading method provided in the above method embodiments, and its principle and technical effect are similar to that of the method embodiments, which will not be repeated here.

Based on the same inventive concept, an embodiment of the present disclosure further provides an electronic device. FIG. 4 is a schematic diagram showing the structure of the electronic device provided in an embodiment of the present disclosure. As shown in FIG. 4, the electronic device provided in this embodiment comprises: a memory 41 for storing a computer program; and a processor 42 that, when executing the computer program, perform the plug-in loading method provided by any of the above embodiments.

Based on the same inventive concept, an embodiment of the present disclosure further provides a computer-readable storage medium stored thereon a computer program that, when executed by a processor, causes the computing device to implement the plug-in loading method provided by any of the above embodiments.

Based on the same inventive concept, an embodiment of the present disclosure further provides a computer program product that, when running on a computer, causes the computing device to implement the plug-in loading method provided by any of the above embodiments.

Based on the same inventive concept, an embodiment of the present disclosure further provides a computer program, comprising: instructions that, when executed by a processor, cause the processor to implement the plug-in loading method provided by any of the above embodiments.

One skilled in the art should understand that, the embodiments of the present disclosure may be provided as a method, a system, or a computer program product. Therefore, embodiments of the present disclosure can take the form of an entirely hardware embodiment, an entirely software embodiment or an embodiment containing both hardware and software elements. Moreover, the present disclosure may take the form of a computer program product embodied on one or more computer-usable storage media having computer-usable program code embodied therein.

The processors may be central processing units (CPUs) or other general-purpose processors, digital signal processors (DSPs), application specific integrated circuits (ASICs), field programmable gate arrays (FPGAs) or other programmable logic devices, or discrete hardware components such as discrete gates or transistors. The general-purpose processor may be a microprocessor, or the processor may be any conventional processor or the like.

The memory may include non-permanent memory in a computer-readable medium, random access memory (RAM) and/or non-volatile memory, such as read only memory (ROM) or flash RAM. The memory is an example of a computer-readable medium.

The computer-readable media include permanent and non-permanent, removable and non-removable storage media. The storage medium can realize information storage by any method or technology. The information can be computer-readable instructions, data structures, program modules, or other data. Examples of computer storage media include, but are not limited to, phase change memory (PRAM), static random access memory (SRAM), dynamic random access memory (DRAM), other types of random access memory (RAM), read-only memory (ROM), electrically erasable programmable read-only memory (EEPROM), flash memory or other memory technologies, CD-ROM, digital versatile disc (DVD) or other optical storage, magnetic cassettes, magnetic tape, magnetic disk storage or other magnetic storage devices, or any other non-transmission media that can be used to store information that can be accessed by computing devices. According to the definition herein, computer-readable media does not include transitory media, such as modulated data signals and carrier waves.

It shall be noted that: the above embodiments are merely illustration of the technical solution of this disclosure, but are not limitation thereof. Although this disclosure has been described in detail with reference to the above embodiment, those ordinary skilled in the art shall understand: the technical solutions recited in the various embodiments described above may be modified or some technical features thereof or all the technical features may be substituted equivalently, such modifications or substitutions do not deviate the nature of the technique from the scope of the technique embodied in the embodiments according to this disclosure.

What is claimed is:

1. A plug-in loading method, comprising:
receiving a first operation for a target application, wherein the first operation is configured to trigger the target application to load a first plug-in;
determining whether the first plug-in is written in a preset language;
determining whether the first plug-in references a function module that does not belong to the first plug-in in response to the first plug-in being written in the preset language;
in response to a target function module that does not belong to the first plug-in is referenced by the first plug-in, generating a second plug-in by converting a reference to the target function module by the first plug-in to a reference to the target function module by a module packager of the target application; and
loading the second plug-in through the target application.

2. The plug-in loading method according to claim 1, wherein the determining whether the first plug-in references the function module that does not belong to the first plug-in comprises:
determining whether the first plug-in references a function module by name;
in response to the first plug-in referencing the function module by name, determining that the first plug-in references the function module that does not belong to the first plug-in;
in response to the first plug-in not referencing the function module by name, determining whether the first plug-in references a function module by path;
in response to the first plug-in referencing the function module by path, determining whether the function module referenced by path by the first plug-in belongs to the first plug-in; and
in response to the function module referenced by path by the first plug-in not belonging to the first plug-in, determining that the function module that does not belong to the first plug-in is referenced by the first plug-in.

3. The plug-in loading method according to claim 1, wherein the generating the second plug-in by converting the reference to the target function module by the first plug-in to the reference to the target function module by the module packager of the target application comprises:
obtaining an identifier of the target function module based on a first mapping relationship in response to the first plug-in referencing the target function module by name, wherein the first mapping relationship comprises a mapping relationship between a name of the target function module and an identifier of the target function module; and
generating the second plug-in by converting the reference to the target function module by the first plug-in to the reference to the target function module by the module packager of the target application according to the identifier of the target function module.

4. The plug-in loading method according to claim 1, wherein the generating the second plug-in by converting the reference to the target function module by the first plug-in to the reference to the target function module by the module packager of the target application comprises:
obtaining an identifier of the target function module based on a second mapping relationship in response to the first plug-in referencing the target function module by a module path, wherein the second mapping relationship comprises a mapping relationship between a path of the target function module and an identifier of the target function module; and
generating the second plug-in by converting the reference to the target function module by the first plug-in to the reference to the target function module by the module packager of the target application according to the identifier of the target function module.

5. The plug-in loading method according to claim 1, further comprising:
in response to the first plug-in being not written in the preset language, converting the first plug-in to a plug-in written in the preset language.

6. The plug-in loading method according to claim 5, wherein the converting the first plug-in to the plug-in written in the preset language comprises:
converting the first plug-in to the plug-in written in the preset language by a compiler integrated into the target application.

7. The plug-in loading method according to claim 6, further comprising:
generating an executable file corresponding to the compiler before the converting the first plug-in to the plug-in written in the preset language by the compiler integrated into the target application; and
encapsulating the executable file corresponding to the compiler into a command line for plug-in language conversion in the target application.

8. The plug-in loading method according to claim 7, wherein a compilation configuration file of the compiler is in a resource file of the target application.

9. The plug-in loading method according to claim 6, further comprising:
generating a declaration file in a preset directory of the target application before the converting the first plug-in to the plug-in written in the preset language by the compiler integrated into the target application, wherein the declaration file is configured for indicating a function module allowed to be referenced by a plug-in in the target application.

10. The plug-in loading method according to claim 9, wherein the converting the first plug-in to the plug-in written in the preset language by the compiler integrated into the target application comprises:
searching for the declaration file in the target application; and
converting the first plug-in to the plug-in written in the preset language by the compiler integrated into the target application and the declaration file.

11-20. (canceled)

21. An electronic device, comprising:
a memory; and
a processor coupled to the memory, the processor configured to, based on instructions stored in the memory, carry out a plug-in loading method comprising:
receiving a first operation for a target application, wherein the first operation is configured to trigger the target application to load a first plug-in;
determining whether the first plug-in is written in a preset language;
determining whether the first plug-in references a function module that does not belong to the first plug-in in response to the first plug-in being written in the preset language;
in response to a target function module that not belonging to the first plug-in is referenced by the first plug-in, generating a second plug-in by converting a reference to the target function module by the first plug-in to a reference to the target function module by a module packager of the target application; and
loading the second plug-in by the target application.

22. A non-transitory computer-readable storage medium stored thereon a computer program that, when executed by a computing device, causes the computing device to implement a plug-in loading method comprising:
receiving a first operation for a target application, wherein the first operation is configured to trigger the target application to load a first plug-in;
determining whether the first plug-in is written in a preset language;
determining whether the first plug-in references a function module that does not belong to the first plug-in in response to the first plug-in being written in the preset language;
in response to a target function module that not belonging to the first plug-in is referenced by the first plug-in, generating a second plug-in by converting a reference to the target function module by the first plug-in to a reference to the target function module by a module packager of the target application; and
loading the second plug-in by the target application.

23-24. (canceled)

25. The electronic device according to claim 21, wherein the determining whether the first plug-in references the function module that does not belong to the first plug-in comprises:
determining whether the first plug-in references a function module by name;
in response to the first plug-in referencing the function module by name, determining that the first plug-in references the function module that does not belong to the first plug-in;
in response to the first plug-in not referencing the function module by name, determining whether the first plug-in references a function module by path;
in response to the first plug-in referencing the function module by path, determining whether the function module referenced by path by the first plug-in belongs to the first plug-in; and
in response to the function module referenced by path by the first plug-in not belonging to the first plug-in, determining that the function module that does not belong to the first plug-in is referenced by the first plug-in.

26. The electronic device according to claim 21, wherein the generating the second plug-in by converting the reference to the target function module by the first plug-in to the reference to the target function module by the module packager of the target application comprises:
obtaining an identifier of the target function module based on a first mapping relationship in response to the first plug-in referencing the target function module by name, wherein the first mapping relationship comprises a mapping relationship between a name of the target function module and an identifier of the target function module; and
generating the second plug-in by converting the reference to the target function module by the first plug-in to the reference to the target function module by the module packager of the target application according to the identifier of the target function module.

27. The electronic device according to claim 21, wherein the generating the second plug-in by converting the reference to the target function module by the first plug-in to the reference to the target function module by the module packager of the target application comprises:
obtaining an identifier of the target function module based on a second mapping relationship in response to the first plug-in referencing the target function module by a module path, wherein the second mapping relationship comprises a mapping relationship between a path of the target function module and an identifier of the target function module; and
generating the second plug-in by converting the reference to the target function module by the first plug-in to the reference to the target function module by the module packager of the target application according to the identifier of the target function module.

28. The electronic device according to claim 21, wherein the processor is further configured to:
in response to the first plug-in being not written in the preset language, convert the first plug-in to a plug-in written in the preset language.

29. The electronic device according to claim 28, wherein the converting the first plug-in to the plug-in written in the preset language comprises:
converting the first plug-in to the plug-in written in the preset language by a compiler integrated into the target application.

30. The electronic device according to claim 29, wherein the processor is further configured to:
generate an executable file corresponding to the compiler before the converting the first plug-in to the plug-in written in the preset language by the compiler integrated into the target application; and
encapsulate the executable file corresponding to the compiler into a command line for plug-in language conversion in the target application.

31. The electronic device according to claim 30, wherein a compilation configuration file of the compiler is in a resource file of the target application.

32. The electronic device according to claim 29, wherein the processor is further configured to:
generate a declaration file in a preset directory of the target application before the converting the first plug-in to the plug-in written in the preset language by the compiler integrated into the target application, wherein the declaration file is configured for indicating a function module allowed to be referenced by a plug-in in the target application.
